(19) United States
(12) Patent Application Publication
(10) Pub. No.: US 2020/0067248 A1
(43) Pub. Date: Feb. 27, 2020

(54) MEASURING DEVICE AND METHOD FOR MEASURING A STATE OF WEAR

(71) Applicant: SCHUNK CARBON TECHNOLOGY GMBH, Bad Goisem (AT)

(72) Inventors: Florian Huber, Bad Ischl (AT); Gottfried Kain, Bad Goisern (AT)

(21) Appl. No.: 16/607,896

(22) PCT Filed: Apr. 6, 2018
(86) PCT No.: PCT/EP2018/058817

§ 371 Date: Oct. 24, 2019

(30) Foreign Application Priority Data
Apr. 28, 2017 (DE) 10 2017 207 265.2

(51) Int. Cl. H01R 39/58; G01N 27/02; H01R 39/26; H01R 39/40; H01R 39/20

(52) U.S. Cl. CPC H01R 39/58; G01N 27/023; H01R 2107/00; H01R 39/40; H01R 39/20; H01R 39/26

(57) ABSTRACT

A method for measuring a state of wear of a consumable friction element, a measuring device and a friction element, in particular a brush or the like. The measuring device includes a sensing device having a sensor. A magnetic field can be produced by means of the sensor, and the friction element can be moved in the magnetic field relative to the sensor. The measuring device comprises an indicator that can be attached to the friction element. The indicator comprises a ferromagnetic, antiferromagnetic and/or ferrimagnetic substance, and a change in the magnetic field can be detected by means of the sensing device as a result of a change in the position of the indicator relative to the sensor.

This application represents the national stage entry of PCT International Application No. PCT/EP2018/058817 filed Apr. 6, 2018, which claims priority of German Patent Application No. 10 2017 207 265.2, filed Apr. 28, 2017, the disclosures of which are incorporated by reference here in their entirety for all purposes.

The disclosure relates to a measuring device, a friction element and a method for measuring a state of wear of a consumable friction element, in particular brush or the like, wherein the measuring device comprises a sensing device having a sensor.

Friction elements of this type, such as carbon brushes for electric engines, are inherently subject to wear due to abrasion of material of the friction element. It is desirable to replace the friction element as early as before it reaches a wear limit which impairs a function. Wear detection systems are therefore regularly used in order to monitor a state of wear of friction elements. Electrical contacts on friction elements or switches which can signal a reaching of a wear limit are well-known in this context. However, wear detection systems of this type do not allow a measuring of a wear or of a remaining length of a consumable contact portion of the friction element which is still available. Therefore, a reaching of a wear limit or an abrasion of a friction surface is only detectable if a sensor or a switch is triggered or actuated within the friction element or on a brush holder, in which the friction element is housed.

A sensor of this type can for example be a so-called indicator wire, which is electrically insulated from the friction element and which is disposed in such a manner that upon reaching a critical length of the friction element, an insulation of the indicator wire is broken through and an electrical contact that indicates wear is established. A so-called pin switching contact can, for example, also be disposed on a brush holder, said pin switching contact pressing against a surface of the friction element in the brush holder by means of a contact finger. A cavity is realized in the surface of the friction element, so that upon abrasion of a contact portion and therefore reaching of a wear length of the friction element, the contact finger can engage in the cavity and can thereby cause a switching pulse of the pin switching contact. Furthermore, providing friction elements with a transponder unit, which can wirelessly communicate with a transmitting and receiving unit, is known. DE 10 2007 009 423 A1 discloses a friction element which is provided with a transponder unit. The transponder unit is destroyed by an abrasive contact with a friction surface, with which the friction element is in contact, when a wear limit of the friction element is reached. The transmitting and receiving unit then detects that the friction element as worn.

The known wear detection systems have the disadvantage that a wear length of a friction element or a length of a consumable contact portion of the friction element cannot be measured absolutely. It is indeed possible to dispose a plurality of sensors on a friction element along its length in order to allow an incremental measuring of the length, but this is expensive and does not allow an actual determination of the length of the friction element at a random point in time during operation. Mechanical sensors and transponders are also comparatively expensive in relation to the manufacturing costs of a friction element.

Therefore, the object of the present disclosure is to propose a measuring device, a friction element and a method for wear detection, which allow a cost-effective measuring of a state of wear.

This object is attained by a measuring device having the features of claim 1, a friction element having the features of claim 6, a method having the features of claim 18 and a use of an indicator having the features of claim 21.

The measuring device for measuring a state of wear of a consumable friction element according to the disclosure, in particular a brush or the like, comprises a sensing device having a sensor wherein a magnetic field can be produced by means of the sensor, wherein the friction element can be moved in the magnetic field relative to the sensor, wherein the measuring device comprises an indicator, wherein the indicator can be attached to the friction element, wherein the indicator comprises a ferromagnetic, antiferromagnetic and/or ferrimagnetic substance, wherein a change in the magnetic field can be detected by means of the sensing device as a result of a change in a position of the indicator relative to the sensor.

Thus, the sensor is disposed adjacent to the friction element in such a manner that it is moveable within the magnetic field of the sensor. An abrasive wear of the friction element naturally leads to a shortening of a length, in particular a wear length of a consumable contact portion of the friction element. The friction element can for example be housed in a brush holder and can be pressed against a commutator or a slip ring of an electric machine by means of a spring, the friction element being useable for transmitting electrical energy. A wear of the contact portion of the friction element then causes a movement of the friction element relative to the sensor or relative to the magnet field generated by the sensor as a result. Since the indicator comprises the ferromagnetic, antiferromagnetic and/or ferrimagnetic substance and since it is attached to the friction element, the indicator influences the magnetic field of the sensor, in particular, when a movement of the indicator occurs together with the friction element as a result of a wear. Such a change in the magnetic field caused by the indicator can be detected by the sensing device. It is therefore possible to detect or determine the magnetic field of the sensor at any time irrespective of an operating state of an electric machine or a transmitting of electrical energy via the friction element and to determine or measure a relative position of the indicator and the related absolute wear length of the friction element from the physical properties of the magnetic field which are influenced by the indicator. In principle, it is also possible that an influencing of the magnetic field by the indicator only starts with a beginning wear of the friction element or that in case of a complete wear of the consumable contact portion of the friction element, the indicator is also worn or vice versa. Overall, an absolute length of a consumable contact portion of the friction element or a length of the friction element can thus be measured using the simplest means.

The sensor can be a coil, wherein an impedance of the coil can be measured by means of a detection circuit of the sensing device. Due to its inductivity or self-induction, a coil can cause an alternating current or current pulse to lag behind in the voltage curve in a delayed manner when an alternating voltage or a pulsed voltage is applied due to a counter-voltage self-induced in the coil. The ferromagnetic, antiferromagnetic and/or ferrimagnetic substance of the indicator causes a change in the inductivity of the coil, which can cause a transformation of the voltage/current/time curve. The change of the coil inductivity can be measured by means of the presence or absence of the indicator in the magnetic field. The principle of measurement is then based on a change of the impedance of the coil and its measuring by means of the detector circuit.

The measuring device can comprise a brush holder for housing a friction element and mounting it in a moveable manner, wherein the sensor can then be fixedly disposed on the brush holder. The sensor can, for example, be positioned in an area of a shaft of the brush holder, which can house the friction element. The sensor is not required to touch the friction element in this context, so that a gap can be realized between the friction element and the sensor. A position of the sensor on the brush holder depends on the nature and design of the indicator. If the sensor is a coil, for example, it is also possible that the sensor is realized so as to extend along the brush holder towards a longitudinal axis of the friction element. The brush holder can, at least in sections, be realized by a plastic material, in order to not shield a magnetic field of the sensor. A receiving opening, for example a bore, in which the sensor can easily be inserted into, can be realized in the brush holder in a particularly simple embodiment.

The sensing device can also comprise an additional sensor, by means of which an additional magnetic field can be produced, wherein the friction element or an additional friction element can be moved in the additional magnetic field relative to the sensor. If the sensing device is responsible for monitoring two friction elements, a sensor can then be positioned on the respective friction element. A plurality of friction elements can thus be measured or monitored at the same time by means of the sensing device. Alternatively or additionally, it is also possible to dispose both the additional sensor and the sensor on one friction element. This can be especially advantageous if the friction element is particularly long and a magnetic field which is adjusted to the length becomes necessary. The sensor and the additional sensor can therefore be positioned so as to be distanced from each other. It is also possible that the additional sensor having the additional magnetic field realizes a magnetic field which is different from the magnetic field of the sensor in order to detect the substance of the indicator even better.

The sensor and the additional sensor can be connected to a detection circuit of the sensing device in series or in parallel. Several friction elements can be monitored in this way, for example by means of the measuring device. In particular a serial connection among the sensors requires a small number of connecting cables, but it is then solely possible to measure all sensors or the friction elements as a whole. A parallel connection of the sensors to the detection circuit, on the other hand, allows a differentiated measuring of single friction elements.

The friction element according to the disclosure for transmitting currents, in particular brush or the like, is realized for measuring a wear length of the friction element by means of a measuring device according to the disclosure. A measuring system is realized by the friction element together with the measuring device.

The material of the friction element can predominantly be graphite. The friction element can, for example, be a brush for making contact with a commutator or a slip ring of an electric machine, preferably an electric motor or a generator. The friction element can also substantially be completely realized by graphite. In this case, the graphite can also comprise a binding agent and proportions of metals. However, the metals serve as performance enhancers of the friction element and are not able to realize the indicator themselves. The substance of the indicator can be different from the material of the friction element in that the substance of the indicator is not required for a provided function of the friction element but only serves to realize the indicator.

The indicator can be attached in sections to the friction element, relative in reference to a length of the friction element. A total length of the friction element with regard to a longitudinal axis of the friction element is understood to be a length of the friction element. The indicator may therefore also be attached to only one portion of the friction element.

An additional indicator can also be attached to the friction element. A position of the respective indicators, and therefore a measuring of a wear length of the friction element, can be determined even more precisely by means of an additional indicator. The additional indicator can be attached to the friction element in a position corresponding to the indicator or in a different position, adjacent or at a distance to said friction element.

According to an embodiment, the indicator can be a coiled strip spring attached to or pressing against the friction element. The coiled strip spring can, for example, be realized by a ferromagnetic substance, in particular spring steel, or said coiled strip spring can comprise this substance. Optionally, the indicator can also be a coil spring. The coiled strip spring can cause a contact pressure on the friction element, said contact pressure pressing the friction element on a commutator or a slip ring, for example. A wear of the friction element due to abrasion then causes a shortening of a length of the friction element, which causes a position of the coiled strip spring to change relative to the sensor. The coiled strip spring can influence the magnetic field of the sensor in this manner, which allows for a length of the friction element to be measured.

In an advantageous embodiment, the indicator can be a coating applied to the friction element. The coating can, for example, be made of the substance of the indicator or comprise said substance and can be realized by an electrochemical process, an electroless reductive deposition, a vapor deposition, a thermal decomposition reaction, by dipping into a molten mass, by a printing process or by adhesively binding a layer. In this case, it is already sufficient, if the coating is comparatively thin, for example <100 μm.

It is especially advantageous, if the friction element realizes the indicator wherein the ferromagnetic, antiferromagnetic and/or ferrimagnetic substance can be added to a material of the friction element. If the friction element is realized by sintering powder, the substance can also be added to the material of the friction element in the form of a powder and can be mixed with said material. Nevertheless, it is possible to only add the substance to the friction element in sections. The substance can change the functional properties of the friction element, but by adding the substance to the material of the friction element, the indicator can be realized in an especially simple and cost-effective manner as part of an already existing production method for friction elements.

The indicator can be realized on its own in a consumable contact portion of the length of the friction element, relative in reference to a length of the friction element. A coupling portion of the friction element which is not used up can then be realized free of an indicator. The contact portion can comprise a contact surface via which a transmission of electrical energy to a contact partner is effected. If the indicator is a coating, the indicator can completely cover the friction element in the contact portion. It is also possible that the indicator only covers one or several surface portions of the contact portion in the contact portion, for example a lateral surface of a rectangular friction element. If the material of the friction element comprises or realizes the indicator, the substance of the indicator can only be present in the consumable contact portion of the friction element. An abrasive removal of the consumable contact portion therefore leads to a consumption of the indicator and therefore to a continuous or proportional change in the magnetic field.

The indicator can be realized on its own in a coupling portion of the length of the friction element, relative in reference to a length of the friction element. The coupling portion can be averted from a contact surface of the friction element and connected to a consumable contact portion of the length of the friction element. Just as the consumable contact portion, the coupling portion can also comprise the indicator as a coating applied there or as an addition in a material of the friction element. The coupling portion serves to connect the friction element to, for example, a stranded wire for connecting the friction element in an electrically conductive manner or for coming into contact with a spring which realizes a contact pressure. An abrasive removal of the coupling portion or a consumption of said coupling portion is therefore not intended. However, by changing a length of the consumable contact portion, the coupling portion can be shifted relative to the sensor, which results in a change in the magnetic field of the sensor. Nevertheless, the indicator itself is not subject to change. If a plurality of indicators is provided, the coupling portion and a consumable contact portion can each comprise an indicator, said indicators being different to each other.

Furthermore, the indicator can be realized on its own in an indicator portion of the length of the friction element in between a coupling portion and a consumable contact portion, relative in reference to a length of the friction element. If the indicator is realized as a coating, the indicator portion can be realized as a comparatively narrow band around a circumference of the friction element. If the indicator is made of a material of the friction element, the indicator portion can be realized as a comparatively thin material strip in the friction element with regard to the length of said friction element. If several indicators are provided, several indicator portions can also be realized. Furthermore, the coupling portion and/or the consumable contact portion can additionally comprise an indicator which is different from the indictor of the indicator portion. Also in this case, it can already be sufficient if a coating or the substance of the indicator is disposed on only one side or side portion of the friction element which faces the sensor.

The substance can be made of iron, cobalt, nickel, their alloys, alloys of iron-silicon, iron-boron, iron-aluminum, aluminum-nickel-cobalt, manganese-antimony, or manganese-bismuth.

The substance can comprise oxides of the elements iron (Fe₂O₃, Fe₃O₄), nickel (NiO), chromium (CrO₂) and/or spinels of type AB₂O₃ on their own or in combination, said spinels of type AB₂O₃ preferably having divalent metal cations (Mg, Mn, fe, CO, Ni, Cu) for the letter A and trivalent metal cations (Fe) for the letter B.

The method for measuring a state of wear of a consumable friction element, in particular a brush or the like, according to the disclosure produces a magnetic field by means of a sensor of a sensing device of a measuring device, wherein the friction element in this magnetic field is disposed relative to the sensor, wherein an indicator of the measuring device is attached to the friction element, said indicator comprising a ferromagnetic, antiferromagnetic and/or ferrimagnetic substance, wherein a change in the magnetic field is detected by means of the sensing device as a result of a change a position of the indicator relative to the sensor. For advantages of the method according to the disclosure, please refer to the description of advantages of the measuring device according to the disclosure.

An impedance of the sensor can be measured by means of the sensing device and can be compared to a reference impedance which is stored in the sensing device, wherein a partial length of a consumable contact portion of a length of the friction element can be determined by a difference of the measured impedance and the reference impedance. If the sensor is a coil, an alternating voltage or a pulsed voltage can be fed in said coil, whereby a phase shift of the alternating voltage or of the pulsed voltage occurs in the electric circuit realized thereby due to a coil inductivity. An impedance of the sensor can be determined by means of the sensing device or by means of a detection circuit of the sensing device. It can be provided, for example, that the impedance of the sensor is set as a reference impedance for a new friction element, which is not yet worn, and to store said impedance in the sensing device. The measuring device can then be calibrated with a friction element. If the friction element is moved relative to the sensor, in particular by abrasion of the contact portion, the impedance of the sensor changes due to the change in the magnetic field of the sensor caused by the indicator. The impedance which is then measured is compared to the reference impedance by the sensing device or the detection circuit. Due to the difference of the measured impedance and the reference impedance determined in this manner, the then remaining partial length of a consumable contact portion can be calculated by the detection circuit. This calculation can be made on the basis of a mathematical function, for example. In principle, the method can be used for any friction element having an indicator, because a calibration of the friction element can take place at all times. This also allows for the measuring device to be used universally for different friction elements which serve for the transmission of electrical energy or for friction elements which are unable to allow a transmission of electrical energy or are not intended for this.

Specifically, it can be provided that a change in the position of the indicator relative to the sensor is continuously measured by means of the sensing device. An absolute state of wear of the friction element or of the partial length of the consumable contact portion can then be measured at all times. This measuring can take place irrespective of a current running through the friction element or of an electric machine being operated. A wear of the friction element in relation to an operation of the electric machine can then be determined by means of the sensing device.

It can be calculated in advance, for example, after how many operating hours of the electric machine the friction element is expected to be completely worn and must be replaced. The replacement of the friction element can therefore be scheduled especially easily.

Further advantageous embodiments of the method can be derived from the description of the features of the dependent claims referring back to device claim 1.

According to the disclosure, an indicator made of a ferromagnetic, antiferromagnetic and/or ferrimagnetic substance having a consumable friction element, in particular a brush or the like, is used for measuring a state of wear of the friction element. Further advantageous embodiments of the use of the indicator can be derived from the description of the features of the dependent claims referring back to device claim 1 and method claim 18.

The disclosure can be used for various applications. An electric machine can, for example, comprise two slip rings, each slip ring being in contact with two brushes, which are each disposed in one brush holder. A coating made of nickel is applied to a rearward end of each brush, said rearward end being averted from the slip ring, and a coil is integrated in the brush holder on a forward end of each brush as a sensor of the sensing device. Signals of the respective coils can be transmitted to a detection circuit of the sensing device via a connection socket on the brush holders.

A three-phase machine can, for example, comprise three slip ring tracks having three brushes, which each have a circumferential brush surface surface-coated with iron on a forward end of the brush, said forward end facing the slip ring tracks. Coils, which are connected in series, can in this case also be integrated in the respective brush holders on a forward end, adjacent to a brush running surface. The brush holders can then be connected in the sensing device via a double-pole connection socket having a detection circuit.

An electric machine can comprise two slip ring tracks of a different polarity, to which three brushes are contacted each, according to another example. The brushes can each comprise a material coating having an addition of iron(III) oxide on a rearward end. In this case, too, coils can be integrated in brush holders near a forward end of the brushes as sensors, which can be connected in parallel. A seven-pole connection socket for transmitting measuring signals to the detection circuit can be realized on the brush holders.

In another example, the electric machine having two slip rings of a different polarity can comprise two brushes on one slip ring, said brushes comprising a thin intermediate layer having an addition of iron powder in an area of a maximum permissible wear length.

The disclosure is described in more detail with the aid of the attached drawings in the following.

In the figures:

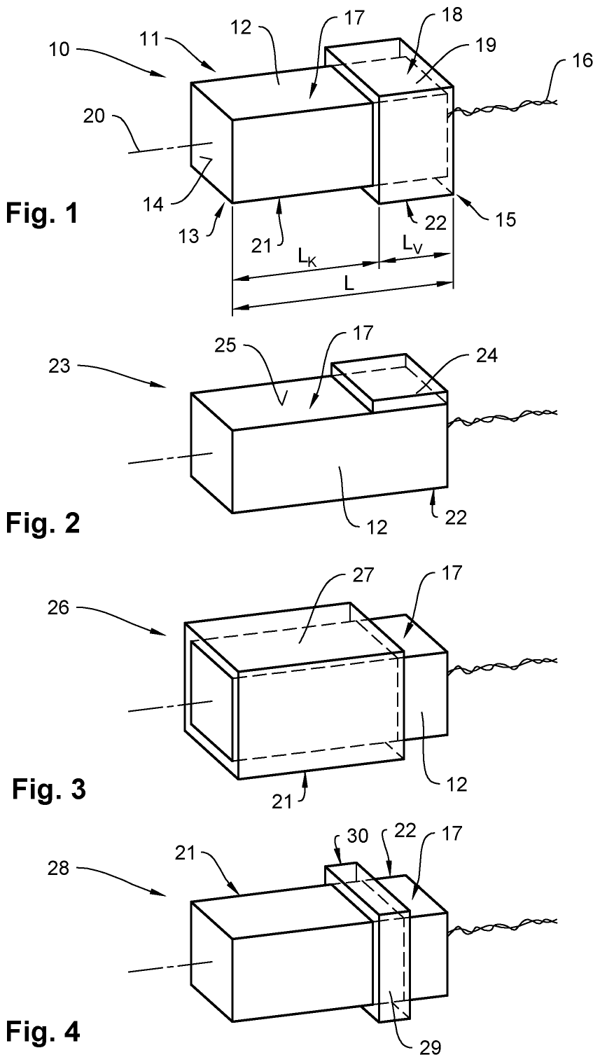

FIG. 1 shows a perspective view of a first embodiment of a friction element;

FIG. 2 shows a perspective view of a second embodiment of a friction element;

FIG. 3 shows a perspective view of a third embodiment of a friction element;

FIG. 4 shows a perspective view of a fourth embodiment of a friction element;

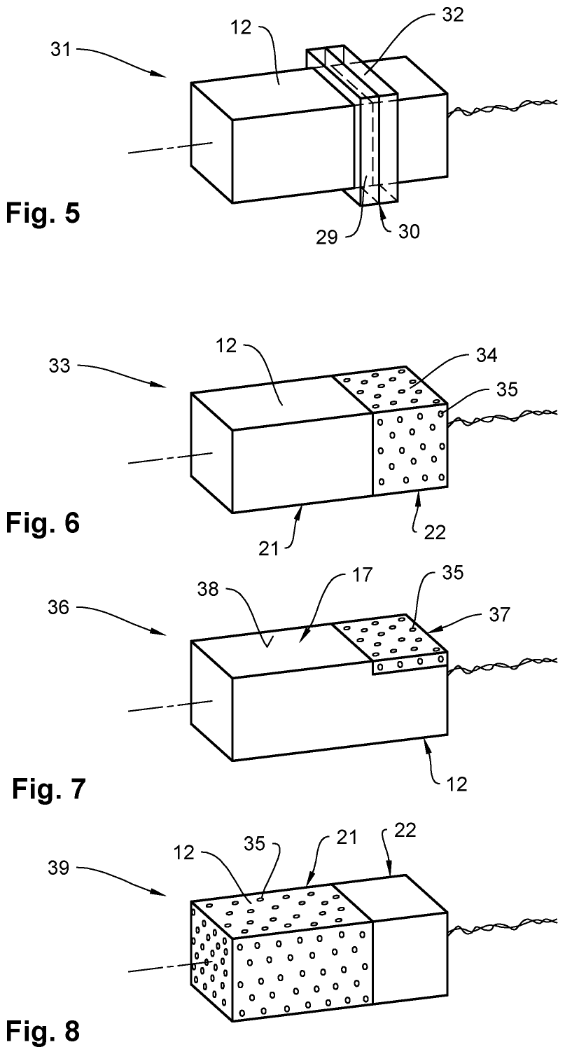

FIG. 5 shows a perspective view of a fifth embodiment of a friction element;

FIG. 6 shows a perspective view of a sixth embodiment of a friction element;

FIG. 7 shows a perspective view of a seventh embodiment of a friction element;

FIG. 8 shows a perspective view of an eighth embodiment of a friction element;

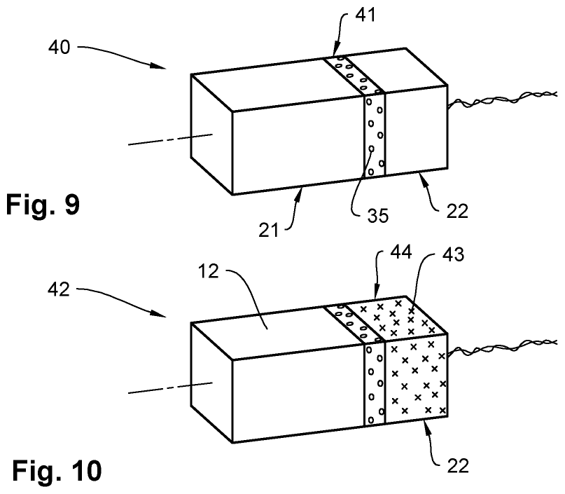

FIG. 9 shows a perspective view of a ninth embodiment of a friction element;

FIG. 10 shows a perspective view of a tenth embodiment of a friction element;

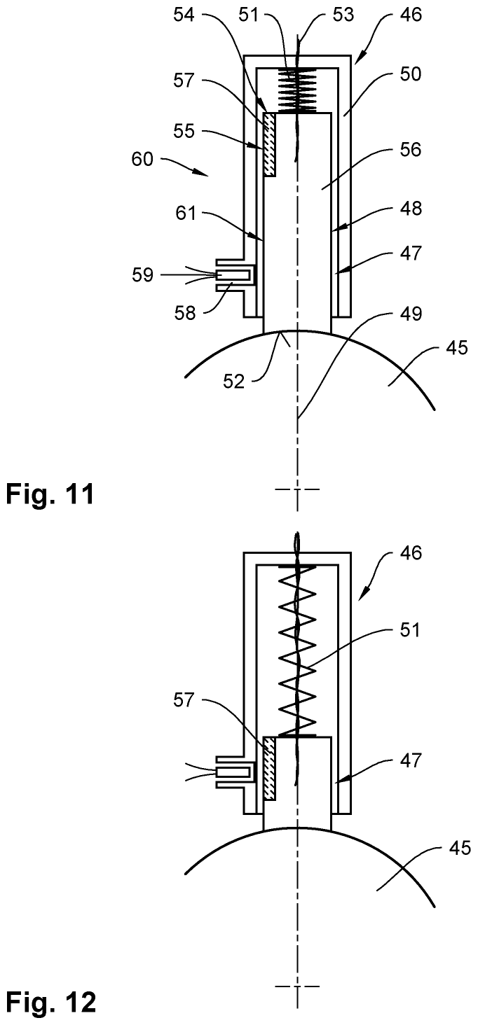

FIG. 11 shows a schematic sectional view of brush holder having an unconsumed friction element;

FIG. 12 shows a schematic sectional view of brush holder from

FIG. 11 having a consumed friction element.

FIG. 1 shows a simplified perspective view of a friction element 10 which realizes a brush 11. A brush body 12 is substantially made of graphite and comprises a contact surface 14 on a forward end 13, said contact surface 14 serving to come in contact with a slip ring of an electric machine (not shown), and a stranded wire 16 on a rearward end 15, said stranded wire 16 being housed in brush body 12 and serving to connect brush 11 in an electrically conductive manner. An indicator 18 is attached to brush 11 or its surface 17 by means of a coating 19. Coating 19 is several micrometers thick and is substantially made of a ferromagnetic substance, wherein coating 19 can alternatively also comprise an antiferromagnetic and/or ferrimagnetic substance. The substance can be iron, cobalt or nickel and alloys of iron-nickel, iron-cobalt, nickel-cobalt, iron-silicon, iron-boron, iron-aluminum, aluminum-nickel-cobalt, nickel-iron-cobalt, manganese-antimony, or manganese-bismuth, for example. Coating 19 is fully applied on surface 17 on rearward end 15 relative to a longitudinal axis 20. Surface 17, on the other hand, does not have a coating and therefore realizes a consumable contact portion 21 having a partial length LK and a length L of brush body 12. As a result, coating 19 is realized in a coupling portion 22 having a length LV of length L of brush body 12. Brush 11 can be used together with a measuring device (not shown) and a brush holder, wherein a magnetic field is produced by means of a sensor of a sensing device of the measuring device and the brush is disposed relative to the sensor in the magnetic field, wherein indicator 18 causes a change in the magnetic field as a result of a change in a position of indicator 18 relative to the sensor due to a consumption of consumable contact portion 21. The measuring device can then use the change in the position of indicator 18 relative to the sensor for determining length LK of consumable contact portion 21.

FIG. 2 shows a friction element 23 which, in contrast to the friction element of FIG. 1, comprises a coating 24, which is only applied on a lateral surface 25 of surface 17 in coupling portion 22. It is important to note that friction element 23 must always be housed in a manner that allows coating 24 to reach a detection area of a sensor. Coating 24 can be applied by means of an adhesive layer (not shown) on lateral surface 25, for example.

FIG. 3 shows a friction element 26 which, in contrast to the friction element of FIG. 1, comprises a coating 27, which is only applied in consumable contact portion 21 on surface 17 of brush holder 12. Coating 27 is worn over the service life of friction element 26 due to an abrasive removal and is substantially completely removed at the end of the service life.

FIG. 4 shows a friction element 28 which, in contrast to the friction element of FIG. 1, comprises a coating 29, which is applied in a transition area of consumable contact portion 21 to coupling portion 22 on surface 17. Coating 29 realizes an indicator portion 30 in this way. If coating 29 passes a sensor due to an abrasive removal of consumable contact portion 21, an impedance of a magnetic field of the sensor can, for example, change from an initial value to a modified value and back to the initial value. It is then possible to detect at least two positions of friction element 28 without precisely calculating a length of friction element 28.

In contrast to the friction element of FIG. 4, friction element 31 shown in FIG. 5 comprises an additional coating 32 in indicator portion 30.

FIG. 6 shows a friction element 33 which, in contrast to the friction element of FIG. 1, comprises an indicator 34 in coupling portion 22 instead of a coating, said indicator being realized as a material of brush body 12 due to an addition of a ferromagnetic, antiferromagnetic and/or ferrimagnetic substance. The substance can be added to the material in the form of particles 35 if brush body 12 is sintered. Particles 35 are substantially distributed in a homogeneous manner in coupling portion 22, wherein no particles of the substance are added to consumable contact portion 21. A principle of a detection corresponds to the friction element shown in FIG. 1.

FIG. 7 shows a friction element 36 which, in contrast to the friction element of FIG. 6, comprises particles 35 only in a section 27 on a lateral surface 38 of coupling portion 22 or surface 17.

FIG. 8 shows a friction element 39 in which, in contrast to the friction element of FIG. 6, particles 35 of the substance are only added to the material of brush body 12 in consumable contact portion 21. Coupling portion 22 does not comprise any particles of the substance.

FIG. 9 shows a friction element 40 in which, in contrast to the friction element of FIG. 6, particles 35 of the substance are only added to the material in an indicator portion 41 between consumable contact portion 21 and coupling portion 22.

FIG. 10 shows a friction element 42 in which, in contrast to the friction element of FIG. 9, additional particles 43 are added to a material of brush body 12 in coupling portion 22, whereby an additional indicator 44 is realized in coupling portion 22.

A combined view of FIGS. 11 and 12 shows a schematic sectional view of a slip ring 45 of an electric machine (not shown in more detail) having a brush holder 46 and a friction element 47, which realizes a brush 48. Brush 48 is moveable along a longitudinal axis 40 within a shaft 50 of brush holder 46. A contact pressure is caused on a contact surface 52 of brush 48 via a spring 51. Electrical energy can then be transmitted to slip ring 45 via contact surface 52 via a stranded wire 53, which is attached to brush 48. Brush 48 is substantially made of graphite, wherein a ferromagnetic, antiferromagnetic and/or ferrimagnetic substance is added to the graphite in a section 54 of a coupling portion 55 of a brush body 56 of brush 48, such that an indicator 57 is realized. A sensor 59 which is substantially realized by a coil (not shown in more detail) is disposed in a cavity 58 on brush holder 46. Sensor 59 and indicator 57 are part of a measuring device 60 (not fully shown). A consumable contact portion 61 of brush body 56 is initially relatively long and is then reduced by an abrasive removal of the material of contact portion 61 so as to cause a position of indicator 57 relative to sensor 59, as can be seen from FIGS. 11 and 12. A magnetic field generated by sensor 59 is also changed by a changed relative positioning of indicator 57, a corresponding change in the length of consumable contact portion 61 being derived from the change in the relative position of indicator 57 of measuring device 60 or of a detection circuit (not shown) on measuring device 60 and the reaching of a wear limit being detected thereby.

1. A measuring device for measuring a state of wear of a consumable friction element wherein the measuring device comprises a sensing device having a sensor
wherein
a magnetic field can be produced by the sensor, wherein the friction element can be moved in the magnetic field relative to the sensor, wherein the measuring device comprises an indicator, wherein the indicator can be attached to the friction element, wherein the indicator comprises a ferromagnetic, antiferromagnetic and/or ferrimagnetic substance, wherein a change in the magnetic field can be detected by means of the sensing device as a result of a change in a position of the indicator relative to the sensor.

2. The measuring device according to claim 1, wherein
the sensor is a coil, wherein an impedance of the coil can be measured by a detection circuit of the sensing device.

3. The measuring device according to claim 1,
wherein
the measuring device comprises a brush holder for housing a friction element and disposing it in a moveable manner, wherein the sensor is fixedly disposed on the brush holder.

4. The measuring device according to claim 1,
wherein
the sensing device comprises an additional sensor that can produce an additional magnetic field, wherein the friction element or an additional friction element can be moved in the additional magnetic field relative to the sensor.

5. The measuring device according to claim 4, wherein
the sensor and the additional sensor are connected to a detection circuit of the sensing device in series or in parallel.

6. A friction element for transmitting currents, realized for measuring a wear length of the friction element by a measuring device according to claim 1.

7. The friction element according to claim 6, wherein
the material of the friction element is predominantly made of graphite.

8. The friction element according to claim 6,
wherein
the indicator is disposed in sections on the friction element, relative in reference to a length (L) of the friction element.

9. The friction element according claim 6,
wherein
an additional indicator is disposed on the friction element.

10. The friction element according to claim 6,
wherein
the indicator is a coiled strip spring disposed on the friction element.

11. The friction element according to claim 6,
wherein
the indicator is a coating disposed on the friction element.

12. The friction element according to claim 6,
wherein
the friction element realizes the indicator wherein the ferromagnetic, antiferromagnetic and/or ferrimagnetic substance is added to a material of the friction element.

13. The friction element according to claim 11,
wherein
the indicator is realized on its own in a consumable contact portion of the length of the friction element, relative in reference to a length (L) of the friction element.

14. The friction element according to claim 11,
wherein
the indicator is realized on its own in a coupling portion of the length of the friction element, relative in reference to a length (L) of the friction element.

15. The friction element according to claim 11,
wherein
the indicator is realized on its own in an indicator portion the length of the friction element in between a coupling portion and a consumable contact portion, relative in reference to a length (L) of the friction element.

16. The friction element according to claim 11,
wherein
the substance is made of iron, cobalt, nickel, their alloys, alloys of iron-silicon, iron-boron, iron-aluminum, aluminum-nickel-cobalt, manganese-antimony, or manganese-bismuth.

17. The friction element according to claim 6,
wherein
the substance comprises oxides of the elements iron (Fe₂O₃, Fe₃O₄), nickel (NiO), chromium (CrO₂) and/or spinels of type AB₂O₃ on their own or in combination, said spinels of type AB₂O₃ having divalent metal cations (Mg, Mn, fe, CO, Ni, Cu) for the letter A and trivalent metal cations (Fe) for the letter B.

18. A method for measuring a state of wear of a consumable friction element
wherein
a magnetic field is produced by a sensor of a sensing device of a measuring device, wherein the friction element in the magnetic field is disposed relative to the sensor, wherein an indicator of the measuring device is disposed on the friction element, said indicator comprising a ferromagnetic, antiferromagnetic and/or ferrimagnetic substance, wherein a change in the magnetic field is detected by the sensing device as a result of a change a position of the indicator relative to the sensor.

19. The method according to claim 18,
wherein
an impedance of the sensor is measured by the sensing device and is compared to a reference impedance which is stored in the sensing device, wherein a partial length of a consumable contact portion of a length (L) of the friction element is determined by a difference of the measured impedance and the reference impedance.

20. The method according to claim 18, wherein
a change in the position of the indicator relative to the sensor (59*is continuously measured by the sensing device.

21. The use of an indicator made of a ferromagnetic, antiferromagnetic and/or ferrimagnetic substance having a consumable friction element, for measuring a state of wear of the friction element.
